(19) United States
(12) Patent Application Publication
(10) Pub. No.: US 2023/0055448 A1
(43) Pub. Date: Feb. 23, 2023

(54) MECHANICAL AUGER RECIRCULATION WELL

(71) Applicant: PYROTEK, INC.

(72) Inventors: Chris T. VILD, Chagrin Falls, OH (US); Jon TIPTON, Aurora, OH (US)

(21) Appl. No.: 17/908,442

(22) PCT Filed: Mar. 2, 2021
(86) PCT No.: PCT/US2021/020509

§ 371 Date: Aug. 31, 2022

Related U.S. Application Data
(60) Provisional application No. 62/983,954, filed on Mar. 2, 2020.

(51) Int. Cl. F27B 3/18; F27D 3/00; C22C 1/02

(52) U.S. Cl. CPC F27B 3/18; C22C 1/02; F27D 3/0026; F27D 3/0033; F27D 2003/0083

(57) ABSTRACT

An apparatus for use in conjunction with a charge well of a furnace containing a molten metal pool into which metal chips are introduced for melting. The apparatus includes a sidewell having a pump well and a charge well. The pump well houses a molten metal pump. The charge well houses a scrap submergence device. The pump well and the charge well are in fluid communication via a passage in a bridge wall that divides the pump well from the charge well. The bridge wall defines a semi-circular end wall of the charge well. The scrap submergence device is capable of clockwise and counterclockwise rotation at variable speed.

The present application claims the benefit of U.S. Provisional Application Serial No. 62/983,954 filed Mar. 2, 2020, the disclosure of which is herein incorporated by reference.

### BACKGROUND

The present disclosure is directed to the introduction of metal chips, especially scrap metal chips of aluminum, magnesium, titanium, and alloys thereof, into a mass of molten metal. The state of the art is represented by U.S. Pat. Nos. 4,702,768, 4,710,126, 4,721,457, and 4,872,907, the disclosures of which are herein incorporated by reference.

Although much progress has been made in the field of conversion of metal chips, and especially recycled metal chips, into utilizable industrial metal by the remelting thereof, as indicated by these patents and their solutions to some of the most significant problems involved, serious economic and environmental shortcomings still remain in the overall procedure, which act as both industrial and economic impediments to the fullest utilization and reutilization of metal chips and their conversion into industrially-utilizable “new” metal.

Some of the most significant challenges involve excessive fuel cost because of heat loss from the furnace in which the mass of molten metal is contained; loss of an excessive amount of metal by conversion to metal oxides because of oxidation of the metal at the surface of the molten metal bath, especially in the charge well of the furnace; pollution problems due to combustion of vaporizable and flammable chip contaminants such as oil, lacquer, or the like, at the surface of the molten metal bath in the charge well; the necessity to employ thermal and/or chemical steps for burning off of vaporizable and flammable contaminants from the chips, as in a rotary-drum type combustion apparatus, to eliminate such contaminants to as great an extent as possible before introduction of the chips into the molten metal bath so as to eliminate excessive flaming and combustion of such vaporized impurities at the surface of the molten metal bath, especially in the charge well, with its attendant difficulty in removing products of combustion; and in efficient use of flux materials for processing/modifying the molten metal.

The method and apparatus of the present disclosure provide improvements in both the process and the apparatus for the utilization of metal chips involving the necessary step of introducing the same into a molten metal bath at the commencement of their reentry into the stream of commerce.

### BRIEF DESCRIPTION

Various details of the present disclosure are hereinafter summarized to provide a basic understanding. This summary is not an extensive overview of the disclosure and is neither intended to identify certain elements of the disclosure, nor to delineate scope thereof. Rather, the primary purpose of this summary is to present some concepts of the disclosure in a simplified form prior to the more detailed description that is presented hereinafter.

According to one embodiment, a system for use in conjunction with a furnace having therein a molten metal pool into which metal chips are introduced for melting is provided. The system includes a sidewell having a pump well and a charge well. The pump well houses a molten metal pump and the charge well includes a scrap submergence device. The pump well and the charge well are in fluid communication via a passage in a bridge wall that divides the pump well from the charge well. The bridge wall defines a curved end wall of the charge well. The scrap submergence device is capable of clockwise and counterclockwise rotation at variable speed, and optionally at adjustable depth.

According to another embodiment, a method for the introduction of metal chips into a molten metal pool in a charge well of a furnace is provided. The process steps include providing a sidewell having a pump well and a charge well. The pump well houses a molten metal pump. The charge well houses a scrap submergence device. The pump well and the charge well are in fluid communication via a passage in a bridge wall that divides the pump well from the charge well. The method further includes the step of providing a molten metal pool in the charge well, providing metal chips and introducing the chips into the charge well, operating the molten metal pump and operating the scrap submergence device in both clockwise and counterclockwise directions to optimize dross distribution on the molten metal surface.

According to a further embodiment, a system for automatically performing a scrap submergence operation is provided. The system includes a sidewell housing a pump well and a charge well. The pump well includes a molten metal pump and the charge well includes a scrap submergence device. The pump well and the charge well are in fluid communication via a passage in a bridge wall that divides the pump well from the charge well. The scrap submergence device is capable of clockwise and counterclockwise rotation at variable speed. At least one sensor configured for determining dross depth on a surface of a pool of molten metal within the charge well is provided. A controller receiving data from the sensor and adjusting the operation of at least one of the pump and scrap submergence device based on the data is also provided.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a top view of a recycle reverberator furnace of the present disclosure;

FIG. 2 is a top view (partially in phantom) of the sidewell of FIG. 1;

FIGS. 3A, 3B and 3C are illustrations of water modeling demonstrating the ability to control surface dross distribution using the apparatus of this disclosure; and

FIG. 4 is a top view (partially in phantom) of the sidewell demonstrating an optional baffle and optional horizontal movement of the scrap submergence device.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used herein, the terms about, generally and substantially are intended to encompass structural or numerical modifications which do not significantly affect the purpose of the element or number modified by such term.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

Recycle reverberatory furnaces (RF) are often used with contaminated scrap, e.g. scrap metal coated with organic materials, and are provided with one or more side wells where the coated scrap is mixed with a flux that enables contaminants to be skimmed off as a floating dross before the molten metal enters the main chamber of the furnace from the side well. Such furnaces may also be used for melting light gauge metal scrap, shredded scrap and metal powders because the flux can isolate the metal from an oxidizing atmosphere as the metal is melted.

The present apparatus provides improved control of dross formation in a sidewell of an RF. It employs a molten metal pump and a scrap submergence device to tune molten metal flow in a uniquely shaped sidewell and control the distribution of dross on the molten metal surface. By controlling the distribution of dross on the molten metal surface it is feasible to encourage re-submergence of the dross below the molten metal surface. Re-submergence has many benefits including extraction of flux otherwise trapped in the dross and removed from the system during dross skimming.

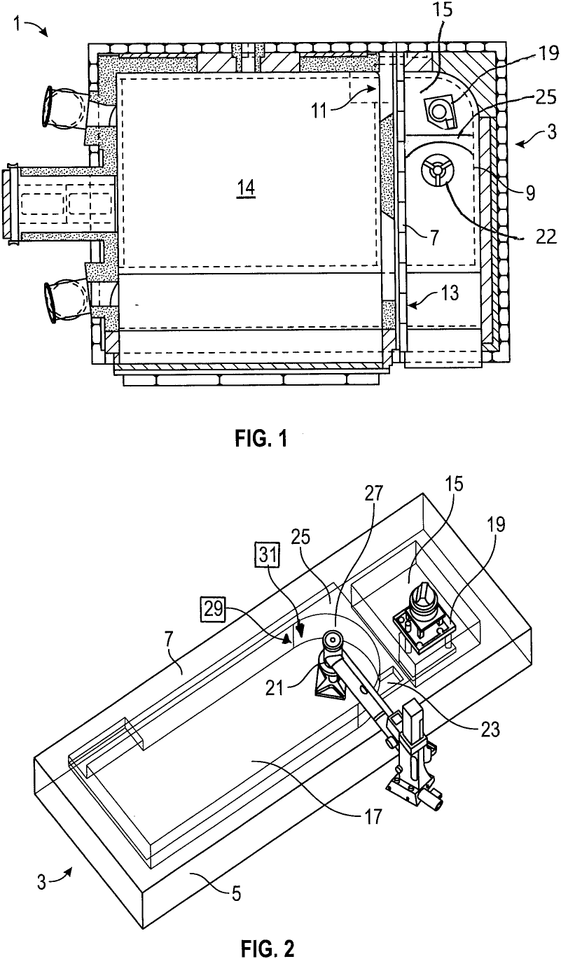

With reference to FIGS. 1 and 2, an exemplary embodiment is illustrated and comprises a reverberatory furnace 1 including a sidewell 3. The sidewell 3 is comprised of an insulated body 5 having a front wall 7 adapted to form part of an insulated wall of the reverberatory furnace 1.

The insulated body 5 further defines and a cavity 9. A metal inlet channel 11 leads directly into the cavity 9 from an inlet aperture in the front wall 7, and a metal outlet channel 13 leads directly from the cavity 9. Cavity 9 is in fluid communication with inlet 11 and outlet 13, allowing molten metal to circulate from a main chamber 14 of the reverberatory furnace 1 to the sidewell 3. The body 5 can be formed as a monolithic block of refractory material.

The sidewell 3 includes a pump well 15 and a charge well 17. The pump well houses a molten metal pump 19. The molten metal pump can be a centrifugal pump or an electromagnetic type available from Pyrotek, Inc. The charge well houses a scrap submergence device 21. The scrap submergence device can be, for example, a Pyrotek SAMS or an MMEI Scrap Eater, modified to be capable of clockwise and counterclockwise rotation of rotor 22 at variable speed. Representative scrap submergence apparatus are described in U.S. Pats. 5,310,412 and 8,449,814, the disclosures of which are herein incorporated by reference.

The pump well 15 and the charge well 17 are in fluid communication via a passage 23 in bridge wall 25 that divides the pump well 15 from the charge well 17. The bridge wall 25 defines a semi-circular end wall 27 of the charge well. As used herein, the term “semi-circular” can encompass a true semi-circle but is also intended to encompass an alternatively curved surface configured to encourage a smooth flow of molten metal for circulation adjacent the bridge wall 25.

A chip-charger 29 of any type can be provided to charge metal chips into the charge well 17. A flux introduction apparatus 31 of any type can be used to introduce flux into the motel metal.

Upon introduction of chips into the molten metal pool in the charge well 17, the chips entering the molten metal pool release gas from vaporizable contaminants or impurities present thereon, which rise to the surface of the pool and form dross. By operating the scrap submergence device in both clockwise and counterclockwise directions at variable speeds and in combination with the flow of molten metal created by the molten metal pump, dross distribution on the molten metal surface can be tuned. Moreover, the flow of molten metal within the charge well can be modified to create surface eddies that move surface dross in a desired fashion. By controlling the spread of surface dross in a manner that prevents excessive thickness from developing, improved metal recovery and salt flux efficiency is advantageously achieved.

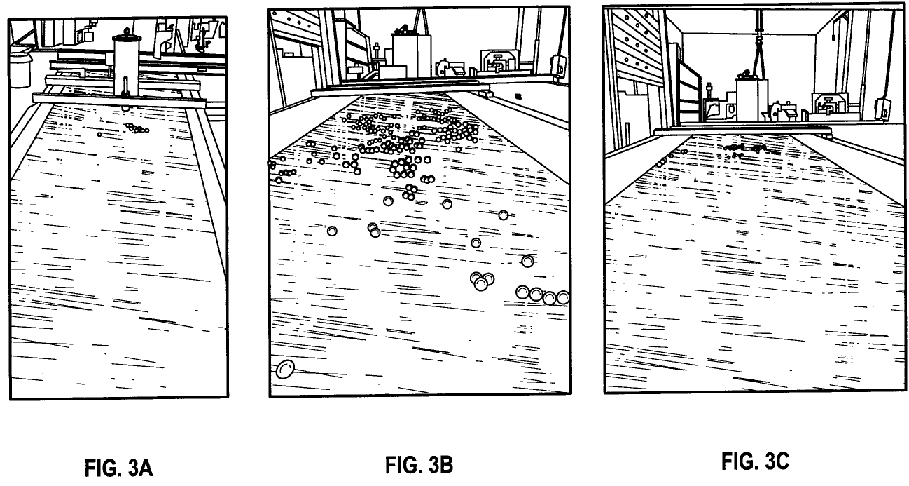

With reference to FIGS. 3A, 3B and 3C, actual experiments performed using water and floating balls are depicted. The experiments were conducted on a system having the configuration of FIGS. 1 and 2 using an actual molten metal pump and scrap submergence device. It can be seen that the dross (balls) can be directed to different locations on the surface of the molten metal (water). For example, in FIG. 3A, with a J50 pump off and a scrap submergence device turning clockwise, dross is encouraged to submerge at the scrap submergence device location. Turning now to FIG. 3B, when the J50 pump is turned on, dross is encouraged to spread evenly on the molten metal surface. FIG. 3C demonstrates how dross can be encouraged to congregate at an upstream location when the J50 pump is turned off and the scrap submergence device is operated in a counterclockwise direction. While spreading of dross can be desirable during scrap/flux introduction, congregation of dross can be a desirable phase when dross skimming is required.

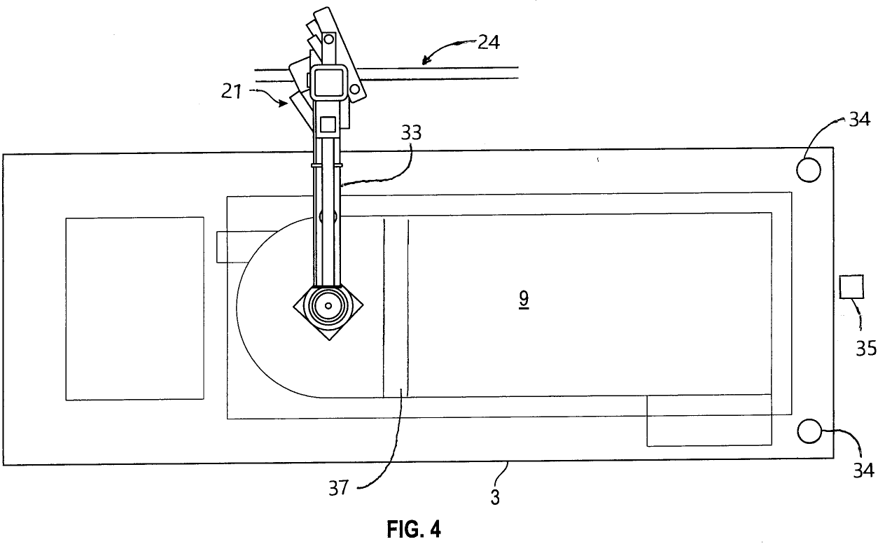

FIG. 4 illustrates a modification to the dross processing operation wherein the scrap submergence device 21 is capable of movement along the length and the width of the sidewell 3. It may be beneficial to have the scrap submergence device mounted to a rail system 24 (or any other mechanism available to the skilled artisan) to facilitate movement on the longitudinal axis of the charge well. Crosswise movement can be accomplished using an extendable/retractable arm 33. It may be similarly desirable to provide the scrap submerging device 21 with vertically adjustability such that depth of the rotor in the molten metal bath can be modified. The ability to reposition the scrap submergence device can further improve the ability to tune flow patterns and re-submerge surface dross.

It is further contemplated that an optional baffle 37 can be provided. The baffle can be supported on the surface of the bath (e.g., between +1" and -6") to discourage floating chunks of large dross pieces from circulation to the scrap submergence device and causing potential damage thereto. The baffle can be vertically adjustable to accommodate variation in the depth of the molten metal bath and to allow lifting when full circulation of surface dross back to the scrap submergence device is desired.

Sensors 34 can be utilized to gauge the depth of surface dross on the pool of molten metal in charge well 9. For example, lasers can be used to measure temperature across the surface of the molten metal pool. Since the recorded temperature will decrease with increasing dross depth, the thickness of the dross layer across the surface of the pool can be determined and the operation of the molten metal pump and scrap submergence device automatically modified by controller 35 (wired or wirelessly interconnected) in accord with known dross distribution parameters (see paragraph [0028]).

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

1. A system for use in conjunction with a furnace having therein a molten metal pool into which metal chips are introduced for melting, the system comprising a sidewell including a pump well and a charge well, the pump well including a molten metal pump, the charge well including a scrap submergence device, said pump well and said charge well being in fluid communication via a passage in a bridge wall that divides the pump well from the charge well, said bridge wall defining a curved end wall of the charge well, and wherein said scrap submergence device is capable of clockwise and counterclockwise rotation at variable speed, and optionally at adjustable depth.

2. The apparatus of claim 1, wherein the molten metal pump is a centrifugal pump or an electromagnetic pump.

3. The apparatus of claim 1 including a height adjustable baffle positioned between the scrap submerging device and an outlet of the sidewell.

4. The apparatus of claim 1 including a scrap feed mechanism.

5. The apparatus of claim 1 including a flux feed mechanism.

6. The apparatus of claim 1, wherein said scrap submergence device comprises a rotor disposed on a shaft.

7. The apparatus of claim 1, wherein said scrap submergence device is horizontally repositionable.

8. The apparatus of claim 6, wherein the rotor is repositionable in a crosswise direction of the charge well.

9. The apparatus of claim 6, wherein the rotor is vertically repositionable.

10. The apparatus of claim 1, wherein the curved end wall comprises a semi-circle.

11. The apparatus of claim 7, wherein said scrap submergence device is mounted to a rail system.

12. A method for melting metal chips comprising the introduction of metal chips into a molten metal pool in a charge well of a furnace for melting therein, and including the steps of:
providing a sidewell of a furnace comprising a pump well and a charge well, the pump well housing a molten metal pump, the charge well housing a scrap submergence device, said pump well and said charge well being in fluid communication via a passage in a bridge wall that divides the pump well from the charge well;
providing a molten metal pool in the charge well;
introducing metal chips into said charge well;
operating said pump; and
operating said scrap submergence device in both clockwise and counterclockwise directions to optimize dross distribution on the molten metal suitable.

13. The method of claim 12 including a controller that adjusts each of the pump speed and the scrap submergence device speed and direction.

14. The method of claim 12 including sensors that adjust each of the pump speed and the scrap submergence device speed and direction based on surface dross distribution.

15. The method of claim 12 including at least the modes (i) molten metal pump on with scrap submergence device off, (ii) molten metal pump on with scrap submergence device operating clockwise, (iii) molten metal pump on with scrap submergence device operating counterclockwise, (iv) molten metal pump off with scrap submergence device operating clockwise, and (v) molten metal pump off with scrap submergence device operating counterclockwise.

16. The method of claim 15, wherein at least a speed of one or both of the molten metal pump and the scrap submergence device is changed during a mode.

17. The method of claim 12, wherein at least one sensor is provided to calculate the relative thickness of dross on a surface of the molten metal within the charge well which is communicated to a controller, and wherein said controller adjusts at least one of the scrap submergence device and the pump.

18. A system for automatically performing a scrap submergence operation, the system comprising a sidewell including a pump well and a charge well, the pump well including a molten metal pump, the charge well including a scrap submergence device, said pump well and said charge well being in fluid communication via a passage in a bridge wall that divides the pump well from the charge well, wherein said scrap submergence device is capable of clockwise and counterclockwise rotation at variable speed, at least one sensor configured for determining dross depth on a surface of a pool of molten metal within the charge well, and a controller receiving data from the sensor and adjusting the operation of at least one of the pump and scrap submergence device based on said data.

19. The system of claim 18, wherein the scrap submergence device is at least one of vertically, horizontally and longitudinally adjustable.

20. The system of claim 18, wherein the bridge wall defines a curved end wall of the charge well.
